(19) United States
(12) Patent Application Publication
(10) Pub. No.: US 2020/0041060 A1
(43) Pub. Date: Feb. 6, 2020

(54) Tool And Method For Additive Introduction Into Closed Systems

(71) Applicant: Uniweld Products, Inc., Fort Lauderdale, FL (US)

(72) Inventors: David S. Pearl, II, Fort Lauderdale, FL (US); Douglas B. Pearl, Hollywood, FL (US); Dragan Bukur, Fort Lauderdale, FL (US)

(21) Appl. No.: 16/478,537

(22) PCT Filed: Jan. 18, 2018
(86) PCT No.: PCT/US2018/014168

§ 371 Date: Jul. 17, 2019

Related U.S. Application Data
(60) Provisional application No. 62/449,665, filed on Jan. 24, 2017.

(51) Int. Cl. F16L 55/164; F25B 45/00

(52) U.S. Cl. CPC F16L 55/164; G01M 3/20; F25B 2345/006; F25B 45/00

(57) ABSTRACT

Device and method for injecting one or more additives into systems, such as a sealing agent to repair leaks in such systems, including air conditioning and refrigeration systems. In certain embodiments, the device is a disposable or single-use device, and includes a hose, tube, or conduit or the like that contains a sealing agent. Introduction of the sealing agent into the closed system allows the sealing agent to travel through the system and seal leaks therein. In some embodiments, one end of the hose is configured to connect to a manifold, and the other end of the device is configured to connect to the unit to be sealed. A check valve prevents unwanted backflow of refrigerant from the unit to be sealed.

This application claims priority of U.S. Provisional patent application Ser. No. 62/449,665 filed Jan. 24, 2017, the disclosure of which is hereby incorporated by reference.

### BACKGROUND

Mechanical air conditioning and refrigeration is accomplished by continuously circulating, evaporating, and condensing a fixed supply of refrigerant in a closed system. Charging or recharging an air conditioning or refrigeration system with refrigerant is done through the low side suction intake fitting with the use of manifold gauges and service hoses. Low-pressure vapor refrigerant is compressed and discharged from a compressor as a high temperature, high-pressure, “superheated” vapor or liquid. The high-pressure refrigerant flows to a condenser, where it is changed to a low temperature, high-pressure liquid. It then flows through a filter dryer to a thermal expansion valve or TXV, for example. The TXV meters the correct amount of liquid refrigerant into an evaporator. As the TXV meters the refrigerant, the high-pressure liquid changes to a low pressure, low temperature, saturated liquid/vapor. This saturated liquid/vapor enters the evaporator and is changed to a low pressure, dry vapor. The low pressure, dry vapor is then returned to the compressor. The cycle then repeats. Other systems may use capillary tubes or the like instead of TXV valves.

The manifold commonly has three refrigeration lines or service hoses connected thereto. One line is connected through the manifold to a low pressure gauge and is used in servicing the low pressure side (suction side) of a refrigeration/air conditioning system. A second line is connected through the manifold to a high pressure gauge and is used in servicing the high pressure side (discharge side) of a refrigeration/air conditioning system. A third line is connected to a port which commonly connects the ports in the manifold leading to the high and low pressure lines. The third line is used for connection to a refrigerant source or some other pressurized source, or a vacuum source.

Flow control is performed by means of high pressure and low pressure valves at the manifold. Whenever any of the aforementioned three lines are connected to a refrigeration or air conditioning system, the lines can be bled to purge the air from the lines so as to avoid contamination of the refrigeration system with non-condensable gas such as air (and moisture in that air).

Occasionally small leaks develop in such closed systems, such as in the coils, often due to deterioration over time. Replacement of defective coils is expensive and time consuming, and requires elimination of the refrigerant from the system, followed by evacuation and recharging the system with refrigerant once the leaking part or parts have been repaired or replaced.

It would be desirable to provide an apparatus and method that quickly and easily repairs small leaks in such systems, without having to remove and replace one or more system components.

It also would be desirable to provide an apparatus and method suitable for introducing any additive into a system, such as a dye for detecting leaks, a sealant for sealing leaks, a drying agent for drying components, etc.

Other objects and advantages of the present invention and advantageous features thereof will become apparent as the description proceeds herein.

### SUMMARY

Problems of the prior art have been addressed by the embodiments disclosed herein, which relate to a device and method for introducing an additive into a system, such as a closed system for repairing and/or detecting leaks in the closed systems, such as air conditioning and refrigeration systems. In certain embodiments, the device is a disposable or single-use device, and includes a hose, tube, conduit or the like that contains or is adapted to contain a sealing agent and/or other additive or additives. Introduction of the sealing agent and/or additive(s) into the system allows the sealing agent or additive(s) to travel through the system and seal leaks therein, and/or perform some other function depending on the nature of the additive(s) and/or system. In some embodiments, one end of the hose is configured to connect to a manifold, such as via a manifold service hose, and the other end of the hose is configured to connect to the unit into which the additive is introduced, such as a unit to be sealed. In some embodiments, this latter connection is a direct connection; i.e., there is no intermediate hose. In some embodiments, a check valve prevents unwanted backflow of refrigerant (or other gas) from the unit into which the additive is introduced. More than one additive may be introduced into the system at the same time or with the same device.

In some embodiments, the region of the device that connects to a closed system such as a leaking unit includes a reverse flow check valve that includes a biasing element, a valve depressor and a seat assembly on which the biasing element sits. The tension on the biasing element is controlled by the positioning of the valve depressor, and the biasing element biases the seat assembly to a normally closed position preventing fluid flow from the hose through the valve and into the unit until force of the biasing element is overcome.

Suitable materials of construction for the hose, tube or conduit include materials that minimize moisture infiltration into the interior volume of the hose, tube or conduit which can prematurely activate the sealing agent or additive, and which are compatible with the additive. In some embodiments, the material should be able to withstand operating pressures, which typically are about 600 psig, and for safety purposes should be able to withstand pressures as high as 800-1600 psig. In certain embodiments, the material may be translucent.

In its method aspects, embodiments disclosed herein relate to connecting the tool to a manifold to enable fluid communication between the access fitting and a driving force such as the high pressure side of a closed system such as an air conditioning or refrigeration unit via a manifold, and connecting the tool to a service port of the unit to enable fluid communication between the service port and the outlet valve of the tool. The manifold is actuated to cause the driving force to overcome the bias of the biasing element and the sealing agent or additive to be introduced into the unit through the service port.

In an alternative embodiment, the sealing agent or additive(s) is blocked from contact with the outlet valve by a rupturable disc, diaphragm or membrane. The disc can be ruptured with an integral piercing member just prior to use to allow fluid to flow through the now ruptured disc and to the outlet valve.

Accordingly, in certain embodiments a tool for injecting one or more additives into a system is provided, the tool comprising a hose having an internal hose bore; an inlet valve having an open and closed position and in fluid communication with the internal hose bore when in the open position; an outlet valve spaced from the inlet valve and having an open and closed position and in fluid communication with the internal hose bore when in the open position, the outlet valve comprising a valve depressor, a biasing element and a seat assembly on which the biasing element sits, the seat assembly being biased by the biasing element so as to prevent fluid flow from the internal hose bore through the outlet valve when in the closed position. In some embodiments, an access fitting can be coupled to the hose and contain the inlet valve in an internal bore of the access fitting, and a nipple can be spaced from the access fitting and coupled to the hose and contain the outlet valve.

In another embodiment, fluid in the hose is prevented from contacting the outlet valve with a rupturable disc, diaphragm or membrane. An integral piercing member is positioned in the tool and is actuatable to rupture the disc to allow fluid flow through the rupture in the disc, such as just prior to when the tool is placed in service to introduce the additive(s) therein into a system.

In certain embodiments, a method of introducing one or more additives into a system having a port is provided, the method comprising providing a tool containing one or more additives, the tool comprising a hose having an internal hose bore; an inlet valve having an open and closed position and in fluid communication with the internal hose bore when in the open position; an outlet valve spaced from the inlet valve and having an open and closed position and in fluid communication with the internal hose bore when in the open position, the outlet valve comprising a valve depressor, a biasing element and a seat assembly on which the biasing element sits, the seat assembly being biased by the biasing element so as to prevent fluid flow from the internal hose bore through the outlet valve when in the closed position; placing the tool in fluid communication with a manifold to enable fluid communication between the inlet valve and a driving force; connecting the tool to the port to enable fluid communication between the port and the outlet valve; actuating the manifold to cause the driving force to overcome the bias of the biasing element and the additive to be introduced into the closed system through the port. Where the tool includes a rupturable disc to block flow of the one or more additives, the method includes rupturing the disc to allow flow through the disc and to the outlet valve.

Although the embodiments disclosed herein are primarily discussed in the context of the additive being a sealing agent, those skilled in the art will appreciate that the tools and methods disclosed herein can contain other fluid materials for introduction into closed systems, including drying agents, dyes and lubricants.

### BRIEF DESCRIPTION OF THE DRAWINGS

Referring to the drawings, in which like numerals represent like parts in the several views:

FIG. 1A is an exploded view of a hose assembly in accordance with certain embodiments;

FIG. 1B is a cross-sectional view of a hose assembly in accordance with certain embodiments;

FIG. 2 is a cross-sectional view of an access fitting in accordance with certain embodiments;

FIG. 3 is a side view of a valve core that can be used with the device in accordance with certain embodiments;

FIG. 4 is a cross-sectional view of a nipple in accordance with certain embodiments;

FIG. 5 is a cross-sectional view of a valve depressor in accordance with certain embodiments;

FIG. 6A is a side view of a biasing element seat assembly in accordance with certain embodiments;

FIG. 6B is a side view of a biasing element and seat assembly in accordance with certain embodiments;

FIG. 7 is an exploded view of a hose assembly in accordance with an alternative embodiment;

FIG. 8A is a top view of a set screw in accordance with certain embodiments;

FIG. 8B is a cross-sectional view of the set screw of FIG. 8A;

FIG. 9 is a cross-sectional view of a nipple in accordance with an alternative embodiment;

FIG. 10A is a cross-sectional view of a piercing sub-assembly shown in a pre-piercing position in accordance with certain embodiments;

FIG. 10B is an enlarged view of a portion of the piercing sub-assembly of FIG. 10A;

FIG. 10C is a cross-sectional view of a piercing sub-assembly shown in a piercing position in accordance with certain embodiments;

FIG. 10D is an enlarged view of a portion of the piercing sub-assembly of FIG. 10C;

FIG. 11 is a cross-sectional view of a housing in accordance with certain embodiments;

FIG. 12 is a cross-sectional view of a piercing nipple in accordance with certain embodiments;

FIG. 13 is a cross-sectional view of the hose assembly of FIG. 7 in an assembled condition;

FIG. 14 is a diagrammatic view of the tool of FIG. 1A attached to a manifold and HVAC unit in accordance with certain embodiments; and

FIG. 15 is a diagrammatic view of the tool of FIG. 7 attached to a manifold and HVAC unit in accordance with certain embodiments.

### DETAILED DESCRIPTION

A more complete understanding of the components, processes and devices disclosed herein can be obtained by reference to the accompanying drawings. The figures are merely schematic representations based on convenience and the ease of demonstrating the present disclosure, and is, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural references unless the context clearly dictates otherwise.

As used in the specification, various devices and parts may be described as “comprising” other components. The terms “comprise(s),” “include(s),” “having,” “has,” “can,” “contain(s),” and variants thereof, as used herein, are intended to be open-ended transitional phrases, terms, or words that do not preclude the possibility of additional components.

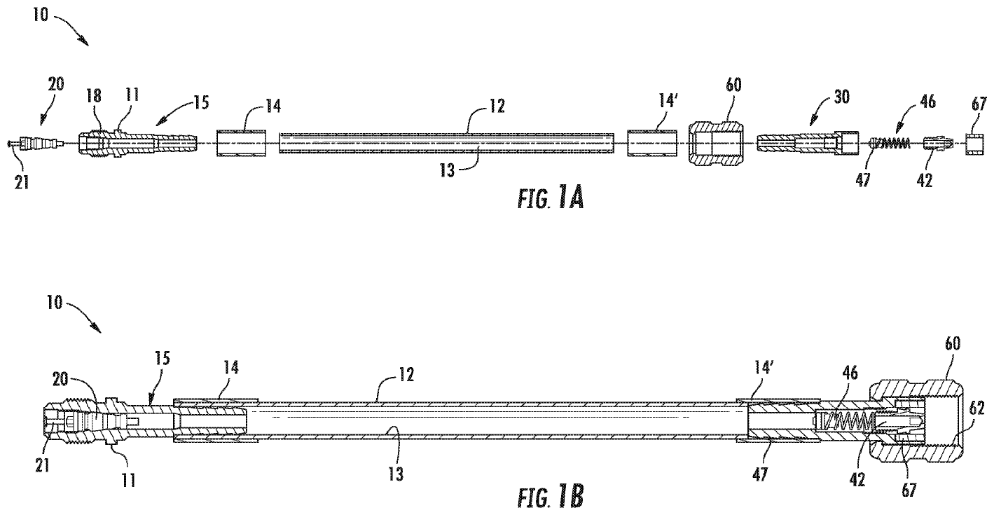

Turning now to FIGS. 1A and 1B, there is shown an injection tool 10 in accordance with certain embodiments. The tool 10 includes an elongated tube 12 having an internal bore 13 that extends the length of the tube 12. Suitable materials of construction for the tube 12 include a PVDF homopolymer and other non-hygroscopic materials, such as fluorinated ethylene propylene (FEP), perfluoroalkoxy alkanes (PFA), polytetrafluoroethylene (PTFE), perfluoroelastomer, and other similar materials that are not deleteriously affected by the sealant and/or additive(s) to be contained by the tube, that are inexpensive and can be disposed of after a single use, and are impervious to moisture. More than one additive may be added sequentially or at the same time. For example, a sealant and an ultraviolet (UV) dye may be introduced into a closed system that has a known leak. If the leak rate is too great for the sealant to seal the leak, the UV dye additive circulates with the system refrigerant's oil and escapes from the system at the leak points which then can be visibly detected with the use of a UV light source.

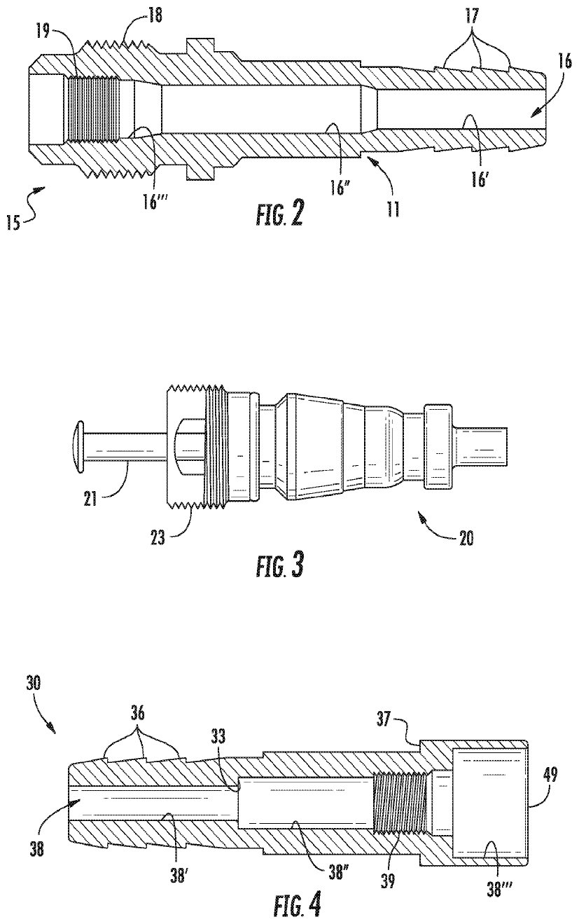

At a first end of tube 12 there is positioned an access fitting 15. As best seen in FIG. 2, in some embodiments the access fitting 15 includes a barbed end having external barbs 17 that help secure the access fitting 15 inside the bore 13 of tube 12. Once the barbed end is inserted into the bore 13 of the tube 12, a hose ferrule 14 or the like can be used to secure the access fitting 15 in place. In certain embodiments, the access fitting 15 includes an internal bore 16 that extends through the access fitting 15. In some embodiments the bore 16 expands in diameter from a first region 16′ of the fitting 15 where the barbs are present to a second intermediate region 16″, and then expands in diameter again from the second intermediate region 16″ to a third region 16′″ that includes internal threads 19. The third region 16′″ also includes external threads 18. In certain embodiments, the access fitting 15 includes an external annular shoulder 11 in the intermediate region 16″ that provides a stop for the ferrule 14. The external threads 18 are configured to threadingly engage with corresponding threads associated with a manifold service hose or the like in fluid communication with the manifold to attach the tool and place it in fluid communication with a driving force such as high pressure refrigerant (e.g., from the closed system being serviced) which may be regulated by the manifold (e.g., the high pressure side of an air conditioning unit). The internal threads 19 are configured to threadingly engage with external threads 23 on a valve core 20 or the like (FIGS. 1A, 1B) that can be positioned in the access fitting 15 such as after the device is loaded with the sealing agent. In some embodiments, the access fitting 15 may be made of a material that is compatible with the additive to be contained by the tool. Depending upon the composition of the additive, suitable materials include brass, plastics such as polyolefins, particularly polypropylene and polyethylene, PVDF, and stainless steel. The access fitting 15 also may be coated or plated with a material that protects the underlying material. For example, a brass access fitting may be nickel plated.

In some embodiments, the valve core 20 positioned or positionable in the bore 16 of the access fitting 15 includes a needle 21 or the like that is biased in an extended position by a biasing element (FIG. 3). Upon attachment of the tool 10 to a manifold (e.g., via a manifold service hose or the like) in fluid communication with a driving force, the needle 21 engages a depressor and is actuated linearly inwardly, towards the tube 10 and against the force of the biasing element, to open a passageway in the valve member for flow of fluid (e.g., high pressure refrigerant) through the access fitting 15 and into the tube 10. In some embodiments, the valve core may be made of a material that is compatible with the additive to be contained by the tool, and/or may be coated or plated with a material that protects the underlying material. For example, a brass valve core may be nickel plated.

In certain embodiments, the opposite end of tube 12 includes a nipple 30, as best seen in FIG. 4. In some embodiments, one end of the nipple 30 includes a barbed end having external barbs 36 that help secure the nipple 30 inside the bore 13 of tube 12. Once the barbed end is inserted into the bore 13 of the tube 12, a hose ferrule 14′ or the like (FIGS. 1A, 1B) can be used to secure the nipple 30 in place. In certain embodiments, nipple 30 includes an internal bore 38 that extends through the nipple 30. In some embodiments the bore 38 expands in diameter from a first region 38′ of the nipple 30 where the barbs 36 are present to a second intermediate region 38″, and then expands in diameter again from the second intermediate region 38″ to a third region 38′″. In certain embodiments, the second intermediate region 38″ includes internal threads 39 that are configured to threadingly engage with external threads on a valve depressor 42 that is positioned in the bore 38 in intermediate region 38″. In some embodiments, the nipple 30 may be made of a material that is compatible with the additive to be contained by the tool, and/or may be coated or plated with a material that protects the underlying material. For example, a brass nipple may be nickel plated.

In some embodiments, a hose nut 60 is positioned over the nipple 30 as seen in FIG. 1B. An annular shoulder 37 on the nipple 30 provides a stop that prevents the hose nut 60 from detaching from the tool 10. The hose nut 60 has internal threads 62 that are configured to threadingly engage with external threads on a service port of air conditioning or refrigeration equipment (not shown), such as the low pressure or suction side. The outside surface of the hose nut 60 may be knurled to facilitate actuation of the hose nut 60 either manually by hand or with a suitable tool.

In certain embodiments, positioned within the nipple 30 is a check valve assembly. In certain embodiments, the check valve assembly includes a valve depressor 42 as best seen in FIG. 5. The valve depressor 42 includes external threads 41 that are configured to threadingly engage the internal threads 39 in the nipple 30 and thereby securely position the valve depressor 42 in the bore 38 of the nipple 30. Relative rotation of the valve depressor 42 and nipple 30 moves the valve depressor axially in the nipple 30. In certain embodiments, the valve depressor 42 includes an internal bore 43, and has an intermediate region that is flared radially outwardly at 44 to help retain or secure seal element 67. In some embodiments the valve depressor 42 includes an end region 45 that tapers radially inwardly towards free end 45′.

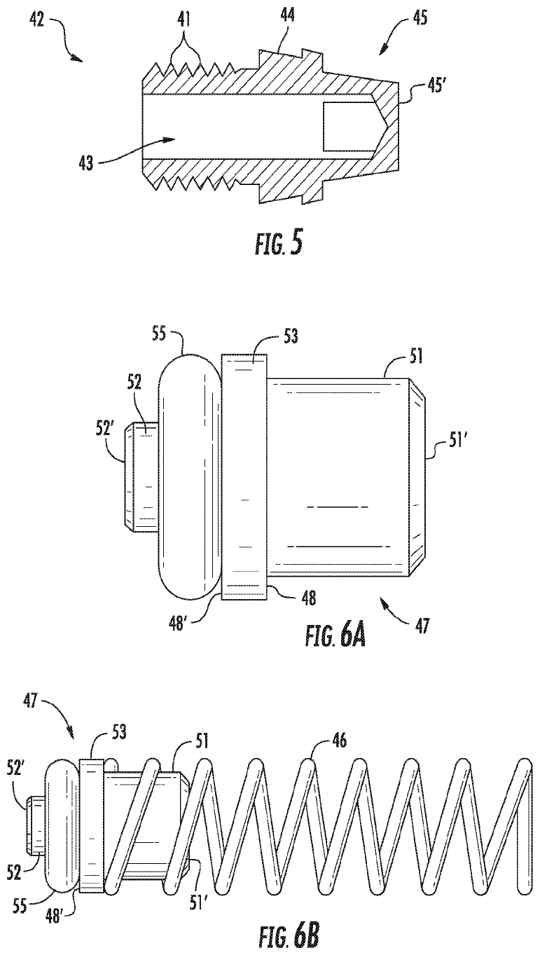

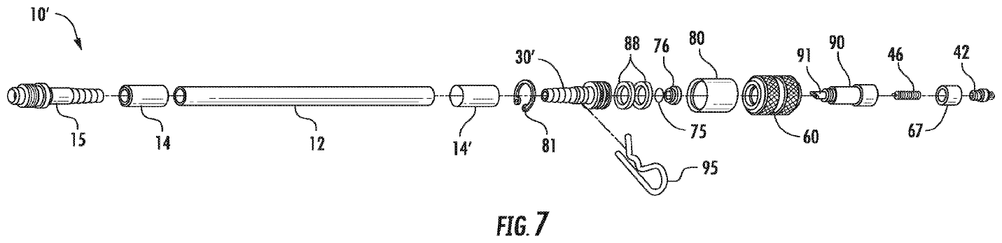

In certain embodiments, a biasing element 46 is positioned in the bore 38 of the nipple 30 as seen in FIG. 1B, and sits on seat assembly 47 (FIG. 6B). In certain embodiments, seat assembly 47 includes a first axially extending projection 51 having a free end 51′, a second axially extending projection 52 having a free end 52′, and an intermediate annular flange 53 that defines with the first axially extending projection 51 a first annular shoulder 48, and defines with the second axially extending projection 52 a second annular shoulder 48′. A sealing member 55 such as an O-ring is seated on the second annular shoulder 48′ as shown in FIGS. 6A and 6B. Seat assembly 47 is positioned in the nipple 30 and abuts against shoulder 33 defining the transition between regions 38′ and 38″ so that the sealing member 55 seals against the shoulder 33. The biasing element 46 sits on annular shoulder 48 of seat assembly 47 (FIG. 6A) and biases the seat assembly 47 against the shoulder 33 of the nipple 30 and thus prevents the additive or sealing agent from escaping from the tube 12 past the seat assembly 47 until the force of the biasing element 46 is overcome. The biasing element 46 is thus compressed between the valve depressor 42 and the seat assembly 47 and in cooperation with the seat assembly 47 and valve depressor 42, acts as a reverse flow check valve. The extent of that compression (e.g., the amount of tension on the biasing element 46), and therefore the amount of force required to counteract the biasing element 46, can be controlled by modifying the position of the valve depressor, by screwing or otherwise actuating the valve depressor 42 towards or away from the seat assembly 47 to move it axially with respect to the nipple 30. In certain embodiments, the seat assembly 47 and sealing member 55 should be of a material that is compatible with the additive. In some embodiments, the seat assembly 47 is made of a fluoropolymer such as PTFE. In some embodiments, the sealing member 55 is made of a nitrile, a perfluoroelastomer, a chlorinated polyethylene, or a highly fluorinated rubber.

In certain embodiments, one or more components of the injecting tool, particularly the seat assembly 47 and the sealing member 55, may be further protected from chemical degradation from the additive by coating them with a lubricant, such as a fluorinated oil or grease such as a perfluoroalkylether lubricant.

The spring-loaded seat 47 assembly thus acts as a back pressure preventer and as a sealing valve to contain the additive such as a sealing agent inside the tube until it is desired to introduce it into the HVAC or refrigeration system.

In some embodiments, a seal element 67, such as a neoprene sleeve, may be positioned in the nipple 30 to help create a seal when the tool 10 is attached to a service port (not shown) of air conditioning or refrigeration equipment.

In certain embodiments, when the tool 10 is in its assembled condition and an additive is introduced into the tube 12, the valve core 20 in the access fitting and the valve in the nipple 30 cooperate to contain the additive in the tube and prevent its escape therefrom. The additive(s) can be introduced into the tool by any suitable means, including introducing it into the first end of the tool prior to inserting the valve core 20, and then confining it in the hose by assembling the valve core 20 in place.

In operation as shown in FIG. 14, in certain embodiments the assembled tool 10 containing sealant and/or additive(s) is connected to a service port 111 of air conditioning or refrigeration equipment by threadingly engaging the hose nut 60 to the service port. The access fitting 15 is connected to a manifold 150, such as via a manifold service hose 112, which is also connected to the high pressure side 115 of the equipment such as via hose 113 (the connection of the access fitting 15 to the manifold 150 can be carried out prior to connecting the tool 10 to a service port 111, if desired). The manifold 150 can then be actuated, allowing pressurized refrigerant from the high pressure side 115 to enter the access fitting 15 and then the tube 12 and overcome the bias of biasing element 46, forcing the sealing agent to flow past the seat assembly 47 and through the nipple 30 into port 111 of the air conditioning or refrigeration equipment that is being serviced. Once the hose is empty of sealing agent and/or additive(s), the driving force from the manifold 150 can be terminated, and the tool 10 disconnected from the manifold 150 and the service port and discarded.

FIG. 7 illustrates an alternative embodiment of an injecting tool 10′. In this embodiment, the access fitting 15, ferrule 14, tube 12 and ferrule 14′ are unchanged. However, at the hose nut 60 end of the tube, a puncturable disc, diaphragm or membrane 75 is provided to ensure that the contents of the tube, such as a sealant or other additive, is sealed in the tube and does not escape from the tube or interact with components of the tool downstream of the disc until the disc 75 is punctured or ruptured. Suitable materials for the disc 75 include PVDF (polyvinylidene fluoride) and PTFE (polytetrafluoroethylene. In certain embodiments, the disc 75 is about 0.005 inches in thickness.

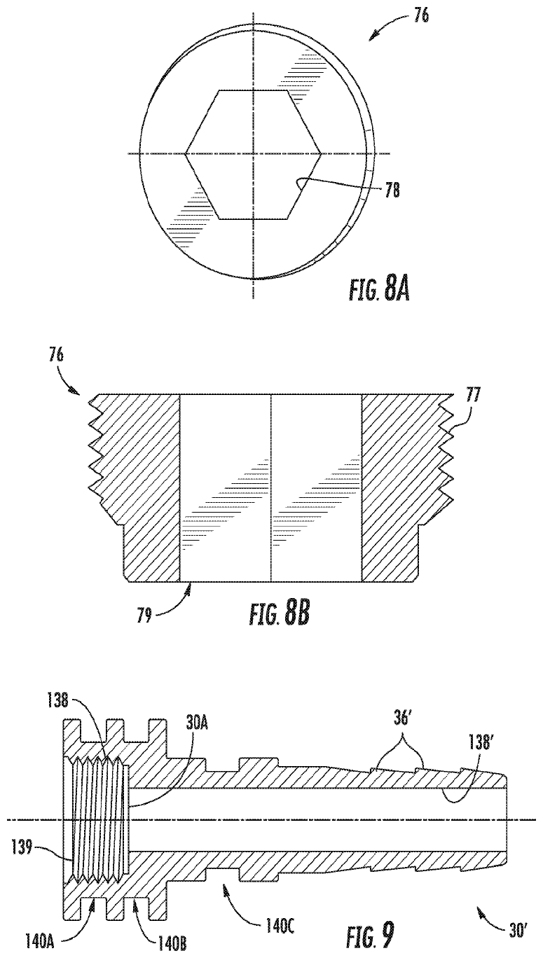

In some embodiments, the disc 75 is held in place in the nipple 30′ with set screw 76. Set screw 76 is best seen in FIGS. 8A and 8B, and includes outer threads 77 that mate with internal threads provided in the nipple 30′. In certain embodiments, the set screw 76 includes a keyed internal bore 78, such as a hexagonal bore, to receive the male end of a hexagonal wrench in order to tighten or loosen the set screw in the nipple 30′. The set screw 76 includes at one free end a face 79 that abuts against a face of the disc 75. The set screw 76 may be made of brass and may be nickel plated.

In certain embodiments, nipple 30′ includes an internal bore 138′ that extends axially through the nipple 30′, as shown in FIG. 9. In some embodiments, the bore 138′ is substantially constant in diameter over its length, until it reaches internally threaded region 138, where it expands in diameter. The internal threads 139 in threaded region 138 are configured to threadingly engage with the external threads on the set screw 76. In some embodiments, one end of the nipple 30′ includes a barbed end having external barbs 36′ that help secure the nipple 30′ inside the bore 13 of tube 12. Once the barbed end is inserted into the bore 13 of the tube 12, a hose ferrule 14′ or the like can be used to secure the nipple 30′ in place. In certain embodiments, the nipple 30′ includes spaced outer annular grooves 140A, 140B configured to receive respective sealing O-rings, and a further spaced outer annular groove 140C configured to receive a retaining ring as discussed in greater detail below. In some embodiments, the nipple 30′ may be made of a material that is compatible with the additive to be contained by the tool, and/or may be coated or plated with a material that protects the underlying material. For example, a brass nipple 30′ may be nickel plated.

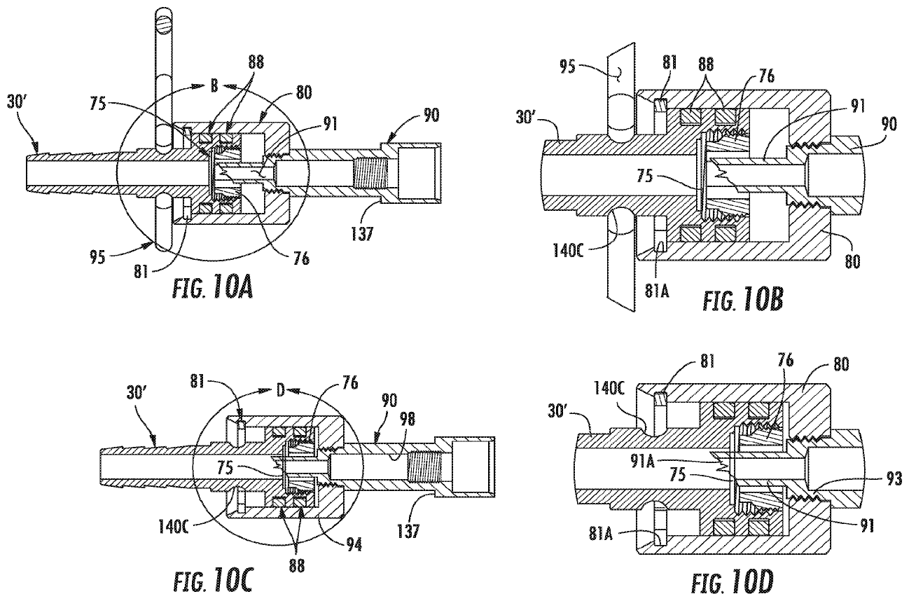

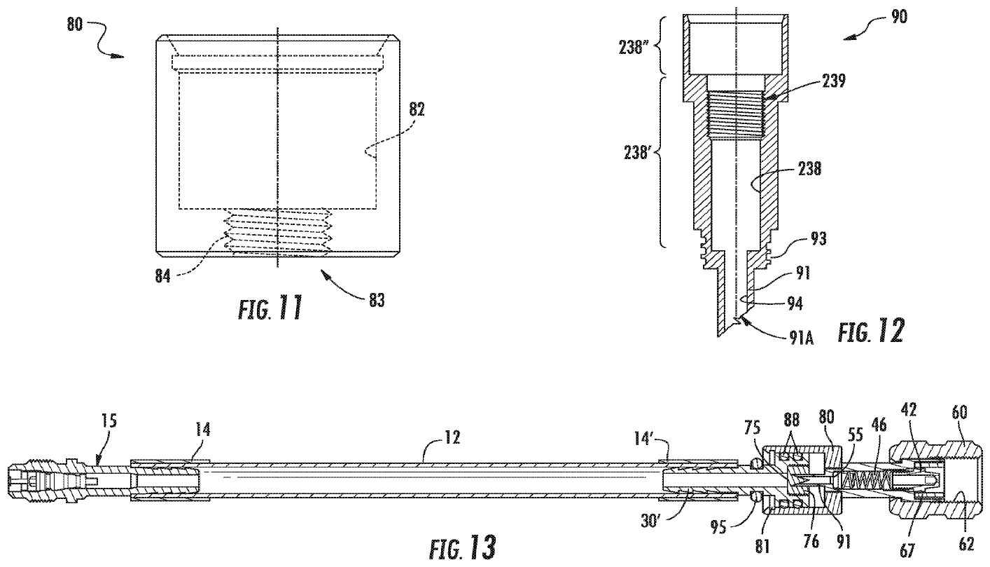

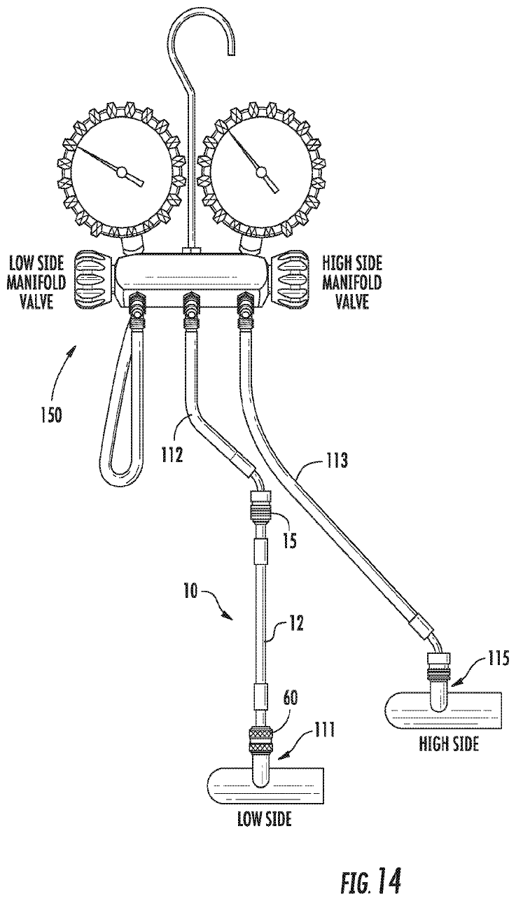

In certain embodiments, nipple 30′ is positioned in housing 80, as seen in FIGS. 10A through 10D. O-rings 88 respectively positioned in grooves 140A, 140B, seal against the inner wall of the housing 80. The outer perimeter of one face of disc 75 abuts against annular shoulder 30A of the nipple 30′, and the other opposite face of disc 75 abuts against the set screw 76, within nipple 30′. In some embodiments, the housing 80 is cylindrical, and includes internal bore 82 leading to inlet 83 having internal threads 84 and having a smaller diameter than the bore 82, as best seen in FIG. 11. The internal threads 84 are configured to mate with external threads 93 on piercing nipple 90, as discussed in greater detail below. Retaining ring 81 is positioned inside the housing 80 as shown and biases against the nipple 30′.

FIG. 12 illustrates an embodiment of piercing nipple 90. In some embodiments, piercing nipple 90 includes a piercing arm 91 having an internal bore 94 in fluid communication with the internal bore 238 of the nipple 90. The arm 91 extends from one end of the nipple 90 and including a free end having one or more sharp or pointed regions 91A, preferably cut on a diagonal such as 45°, effective to pierce or rupture the disk 75 upon the application of sufficient force, thereby allowing fluid flow through the resulting rupture. The piercing nipple 90 also includes external threads 93 configured to threadingly engage with internal threads 84 of the housing 80 to couple the piercing nipple 90 to the housing 80. In certain embodiments, piercing nipple 90 includes an internal bore 238 that extends through the nipple 30. In some embodiments, the bore 238 expands in diameter from a first region 238′ of the piercing nipple 90 to a second region 238″. In certain embodiments, the first region 238′ includes internal threads 239 that are configured to threadingly engage with external threads on a valve depressor 42 that is positioned in the bore 238 in first region 238′. In some embodiments, the piercing nipple 90 may be made of a material that is compatible with the additive to be contained by the tool, and/or may be coated or plated with a material that protects the underlying material. For example, a brass nipple may be nickel plated.

As seen in FIGS. 10A through 10D, the housing 80 is moveable relative to the nipple 30′ between a disc 75 non-pierced position (FIGS. 10A and 10B) and a disc 75 pierced position (FIGS. 10C and 10D). A removable stop 95, such as a hairpin cotter pin, can be provided, such as in annular groove 33 of nipple 30′, to prevent axial movement, in the direction towards the stop 95, of the housing 80 and the components coupled to the housing. As shown in FIGS. 10A and 10B, in the assembled, unused position, the piercing arm 91A of the piercing nipple 90 is positioned just to the right of the disc 75, i.e., axially spaced from (or slightly contacting) the disc 75 but not penetrating through it. After removal of the stop 95, actuation of the housing 90 from the position of FIGS. 10A and 10B to the piercing position of FIGS. 10C and 10D, such as by sliding the housing 80 (and thus the piercing nipple 90 coupled to it) axially towards the access fitting 15 end of the tool 10, causes the piercing arm 91A to contact and rupture through the disc 75. Fluid is now free to flow through the resulting rupture(s), and through the internal bores 94 and 238 of the piercing arm 91 and piercing nipple 90.

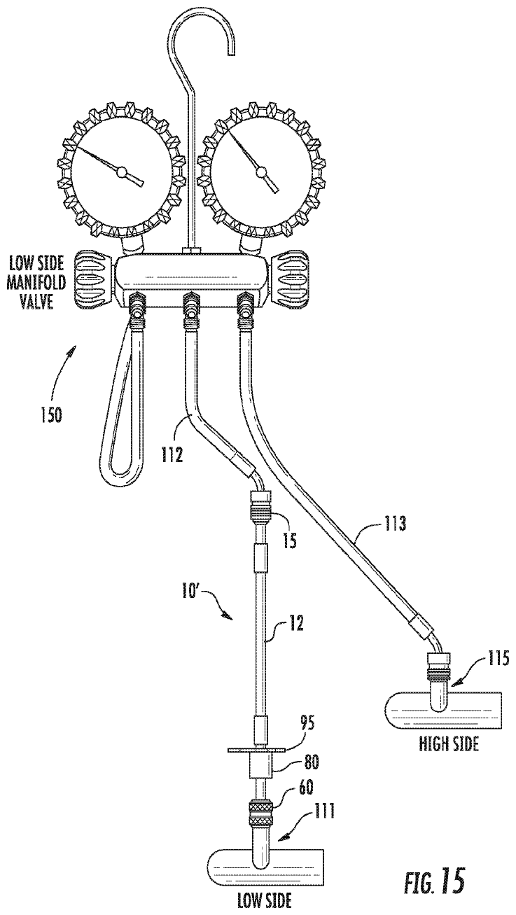

In some embodiments, the hose nut 60 is positioned over the piercing nipple 90 as seen in FIG. 13, in a manner similar to how the hose nut 60 is positioned over nipple 30 in the embodiment of FIGS. 1A and 1B. An annular shoulder 137 on the nipple 90 provides a stop that prevents the hose nut 60 from detaching from the tool 10′. The hose nut 60 has internal threads 62 that are configured to threadingly engage with external threads on a service port of air conditioning or refrigeration equipment (not shown), such as the low pressure or suction side. Also similar to the embodiment of FIGS. 1A and 1B, biasing element 46 is positioned in the bore 238 of the piercing nipple 90 and sits on seat assembly 47, as is valve depressor 42 that includes external threads 41 that are configured to threadingly engage the internal threads 239 in the nipple 90 and thereby securely position the valve depressor 42 in the bore 238 of the nipple 90. Relative rotation of the valve depressor 42 and nipple 90 moves the valve depressor axially in the nipple 90.

In certain embodiments, similar to the embodiment of FIGS. 1A and 1B, a biasing element 46 is positioned in the bore 238 of the nipple 90 as seen in FIG. 13, and sits on seat assembly 47. A seal element 67, such as a neoprene sleeve, may be positioned in the nipple 90 to help create a seal when the tool 10′ is attached to a service port (not shown) of air conditioning or refrigeration equipment. As biasing member 46, seat assembly 47, sealing member 55 and seal element 67 are the same as in the embodiment of FIGS. 1A and 1B, and their operation is the same, they will not be further discussed in the context of the embodiment of FIG. 7.

In operation as shown in FIG. 15, in certain embodiments the assembled tool 10′ containing sealant and/or additive(s) may be placed in condition for use by rupturing the disc 75. This can be carried out before or after the access fitting 15 is connected to a manifold 150, and before or after the tool 10′ is connected to the port 111. To rupture the disc 75, the stop 95 is removed and the housing 80 is actuated to cause the piercing arm 91 of the piercing nipple 90 to contact and rupture through the disc 75. The access fitting 15 is connected to a manifold 150 (if not already carried out), such as via a manifold service hose 112, which is also connected to the high pressure side 115 of the equipment such as via hose 113. The hose nut 60 is connected to a service port 111 (if not already carried out) of an air conditioning or refrigeration unit such as by threading engagement, preferably immediately after rupturing the disc 75. The manifold 150 can then be actuated, allowing pressurized refrigerant from the high side of the unit to enter the access fitting 15 and then the tube 12 and overcome the bias of biasing element 46, forcing the sealing agent to flow past the seat assembly 47 and through the piercing nipple 90 into the air conditioning or refrigeration equipment that is being serviced. Once the hose is empty of sealing agent and/or additive(s), the driving force from the manifold 150 can be terminated, and the tool 10′ may be disconnected from the manifold 150 and the service port 111 and discarded.

What is claimed is:

1. A tool for injecting an additive into a closed system, comprising: a hose having an internal hose bore; an inlet valve having an open and closed position and in fluid communication with said internal hose bore when in said open position; an outlet valve spaced from said inlet valve and having an open and closed position and in fluid communication with said internal hose bore when in said open position, said outlet valve comprising a valve depressor, a biasing element and a seat assembly on which said biasing element sits, said seat assembly being biased by said biasing element so as to prevent fluid flow from said internal hose bore through said outlet valve when in said closed position.

2. The tool of claim 1, wherein said valve depressor is axially movable so as to control the tension of said biasing element.

3. The tool of claim 1, wherein said internal hose bore contains said additive.

4. The tool of claim 3, wherein said additive is a sealing agent.

5. The tool of claim 1, wherein said inlet valve is a valve core.

6. The tool of claim 1, wherein said hose comprises first and second spaced ends, and further comprising an access fitting attached to said first end and containing said inlet valve.

7. The tool of claim 1, wherein said hose comprises first and second spaced ends, and further comprising a nipple attached to said second end, said nipple containing said outlet valve.

8. The tool of claim 1, wherein said inlet valve is nickel plated.

9. The tool of claim 1, wherein said seat assembly comprises a sealing member.

10. The tool of claim 9, wherein said sealing member is an O-ring.

11. A method of introducing an additive into a system having a high pressure port and a low pressure port, comprising:
a. providing a tool containing said additive, said tool comprising a hose having an internal hose bore; an inlet valve having an open and closed position and in fluid communication with said internal hose bore when in said open position; an outlet valve spaced from said inlet valve and having an open and closed position and in fluid communication with said internal hose bore when in said open position; said outlet valve comprising a valve depressor, a biasing element and a seat assembly on which said biasing element sits, said seat assembly being biased by said biasing element so as to prevent fluid flow from said internal hose bore through said outlet valve when in said closed position;
b. placing said tool in fluid communication with a manifold to enable fluid communication between said high pressure port and said low pressure port through said tool;
c. connecting said tool to said low pressure port to enable fluid communication between said low pressure port and said outlet valve;
d. actuating said manifold to create fluid communication between said high pressure port and said low pressure port through said tool by overcoming the bias of said biasing element, causing said additive to be introduced into said system through said low pressure port.

12. The method of claim 11, wherein said additive is a sealing agent.

13. The method of claim 11, wherein said system is a closed system selected from an air conditioning unit and a refrigeration unit.

14. A tool for injecting an additive into a system, comprising: a hose having an internal hose bore; an inlet valve having an open and closed position and in fluid communication with said internal hose bore when in said open position; an outlet valve spaced from said inlet valve and having an open and closed position and in fluid communication with said internal hose bore when in said open position, said outlet valve comprising a valve depressor, a biasing element and a seat assembly on which said biasing element sits, said seat assembly being biased by said biasing element so as to prevent fluid flow from said internal hose bore through said outlet valve when in said closed position; a rupturable disc positioned to block fluid flow to said outlet valve; and a piercing member movable in said tool to rupture said rupturable disc and allow fluid flow through said rupturable disc to said outlet valve.

15. The tool of claim 14, wherein said piercing member comprises a piercing arm having a piercing arm internal bore.

16. The tool of claim 14, further comprising a housing in which said rupturable disc and piercing arm are positioned.

17. The tool of claim 16, further comprising a removable stop member positioned to prevent axial movement of said housing.

18. A method of introducing an additive into a system having a low pressure port and a high pressure port, comprising:
a. providing a tool containing said additive, said tool comprising a hose having an internal hose bore; an inlet valve having an open and closed position and in fluid communication with said internal hose bore when in said open position; an outlet valve spaced from said inlet valve and having an open and closed position and in fluid communication with said internal hose bore when in said open position, said outlet valve comprising a valve depressor, a biasing element and a seat assembly on which said biasing element sits, said seat assembly being biased by said biasing element so as to prevent fluid flow from said internal hose bore through said outlet valve when in said closed position; a rupturable disc positioned to block fluid flow to said outlet valve; and a piercing member actuatable in said tool to rupture said rupturable disc and allow fluid flow through said rupturable disc to said outlet valve;
b. placing said tool in fluid communication with a manifold to enable fluid communication between said high pressure port and said low pressure port through said tool;
c. actuating said piercing member to rupture said disc;
d. connecting said tool to said low pressure port to enable fluid communication between said low pressure port and said outlet valve;
e. actuating said manifold to create fluid communication between said high pressure port and said low pressure port through said the bias of said biasing element and causing said additive to be introduced into said system through said low pressure port.

19. The method of claim 19, wherein said system is a closed system selected from an air conditioning unit and a refrigeration unit.
